(19) United States
(12) Patent Application Publication
(10) Pub. No.: US 2026/0118661 A1
(43) Pub. Date: Apr. 30, 2026

(54) ISOLATION ENCLOSURE FOR OPTICAL DEVICES AND SYSTEMS AND METHODS THEREOF

(71) Applicant: Caterpillar Inc., Peoria, IL (US)

(72) Inventors: Charles Taylor HUDSON, Sherman, TX (US); Rex Aaron GLOVER, Deer Creek, IL (US)

(73) Assignee: Caterpillar Inc., Peoria, IL (US)

(21) Appl. No.: 18/931,263

(22) Filed: Oct. 30, 2024

(51) Int. Cl. G02B 27/00; B08B 5/02; G06T 7/00

(52) U.S. Cl. CPC G02B 27/0006; B08B 5/02; G06T 7/0004; G06T 2207/30168

(57) ABSTRACT

An isolation chamber for an optical device can include an enclosure and an inlet port constructed to supply an isolation medium into the enclosure. An exit tube is constructed to direct a stream of the isolation medium out of the enclosure, the exit tube having a length and an inner diameter. The exit tube can extend into the enclosure, the length, the inner diameter and the distance from a lens of the optical device and the exit tube can establish a selected field of view and the exit velocity of the stream of the isolation medium passing through the exit tube at the forward of the end thereof.

### TECHNICAL FIELD

The present disclosure generally relates to mitigation devices, systems, and methods, and more specifically to an enclosure for an optical device used in high debris or dust environments and systems and methods thereof.

### BACKGROUND

Equipment may be implemented in environments with a high amount of dust, debris, or other contaminants or particulates, such as construction, mining, military, or agricultural sites or locations. Such environment may expose optical devices (including those with or without emitters) of the equipment to high velocity debris as well as contamination from other particulates such as dust that could interfere with emission or detection such as would occur with visible and non-visible spectrum cameras, lights, or other non-visible wavelength emission and detection devices. As but one example, such optical devices may be used in conjunction with analysis of material (e.g., cuttings) associated with surface drilling.

When the optical device becomes dirty, periodic maintenance is needed to clean the optical device. Some environments may have an extreme amount of dust or debris which requires frequent cleaning. The periodic maintenance may require in site operations to cease while the optical device is cleaned. The cleaning may be additionally troublesome if the equipment is located in a relatively inaccessible position and/or if additional service personnel are needed for cleaning. These difficulties may be further compounded when the optical device is used in conjunction with remotely operated equipment or machinery. Additionally, the amount of dust and debris in such locations may be unsafe or unhealthy for people. As such, service personnel are often required in environments in which people are not or should not be present. Further, the equipment may be in a location which is difficult to access, thereby requiring specialized equipment to clean the optical device.

Due to the time, care, and specialized tools required to keep such optical devices clean, use of additional equipment with such optical devices to remotely clean the optical devices may be implemented. While such additional equipment may provide the ability to clean the optical devices once they become dirty without the need of additional service personnel, the additional equipment may not suitably prevent the optical device from getting dirty and may require site operations to cease such that the additional equipment may clean the optical device.

U.S. Pat. No. 7,522,834 (“the '834 patent”) is directed to a camera housing with self-cleaning view ports. According to the '834 patent, the apparatus maintains an unobstructed view for visual monitoring equipment comprising a housing to isolate the visual monitoring equipment from an external environment. An inlet to the housing is connectable to a source of gas under pressure and at least one outlet defining a view port to allow the visual monitoring equipment to acquire images external to the housing and to allow gas to exit the housing.

### SUMMARY

In one aspect of the present inventive concept, an isolation chamber for an optical device includes an enclosure and an inlet port constructed to supply an isolation medium into the enclosure. An exit tube is constructed to direct a stream of the isolation medium out of the enclosure, the exit tube having a length and an inner diameter. The exit tube extends into the enclosure, the length, the inner diameter and the distance from a lens of the optical device and the exit tube establishing a selected field of view and the exit velocity of the stream of the isolation medium passing through the exit tube at the forward of the end thereof.

In another aspect of the present inventive concept, a work machine that generates debris during a work task includes an optical device constructed to analyze the debris and an isolation chamber having an enclosure. An inlet port is constructed to supply an isolation medium into the enclosure. An exit tube is constructed to direct a stream of the isolation medium out of the enclosure, the exit tube having a length and an inner diameter. The exit tube extends into the enclosure, the length, the inner diameter and the distance from a lens of the optical device and the exit tube establishing a selected field of view and the exit velocity of the stream of the isolation medium passing through the exit tube at the forward of the end thereof.

### BRIEF DESCRIPTION OF THE DRAWINGS

FIG. 1 is an illustration of an exemplary environment in which the present inventive concept can be embodied.

FIG. 2 is a schematic block diagram of an exemplary system for dust, debris, and/or contaminant mitigation (which can include prevention) by which the present inventive concept can be embodied according to one or more embodiments of the present disclosure.

FIG. 3 is a sectional view of an optical device with which the present inventive concept can be embodied according to one or more embodiments of the present disclosure.

FIG. 4 is an illustration of an exemplary isolation chamber by which the present inventive concept can be embodied according to one or more embodiments of the present disclosure.

FIG. 5 is an illustration of an exemplary optical device by which the present inventive concept can be embodied according to one or more embodiments of the present disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION OF EXAMPLE EMBODIMENTS

The present inventive concept is best described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments.

The present disclosure generally relates to mitigation (including prevention) devices, systems, and methods, and more specifically to an enclosure for an optical device (which may or may not include an emitter) used in environments that involve relatively high amounts of debris, dust, or other airborne particulates, and systems and methods thereof, for the accumulation mitigation of such debris, dust, or other airborne particulates on the optical device. Such environments may include work or construction sites, such as, but not limited to, environments involving drilling or mining operations.

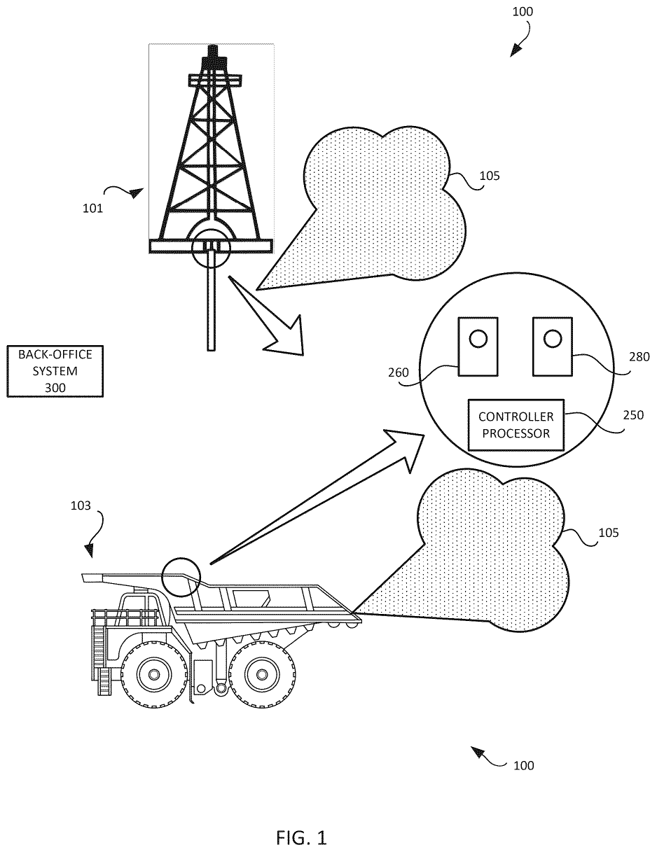

FIG. 1 is an illustration of exemplary environments 100, in the examples shown having at least one work machine in the form of a drilling machine 101 and at least one work machine in the form of a hauling machine 103, by which the present inventive concept can be embodied. It is to be understood that the work machines 101, 103 shown in FIG. 1 are but mere examples of how the present inventive concept can be embodied. As will become apparent from the description that follows, the present inventive concept can be embodied in different configurations, apparatuses, machines, etc., particularly in cases where particulate clouds 105 are or are likely to be present and/or generated. Other debris-creating machines, stationary or mobile, e.g., excavators, road graders, etc., may benefit from realizing the present inventive concept as described herein. And to be clear, embodiments of the present disclosure are not limited to the context of dust or debris-creating machines and may additionally or alternatively be implemented in the context of the dust, debris, or other particulates generated by other factors such as weather (e.g., wind, dryness, etc.). Thus, embodiments of the present disclosure can involve any product having an optical device and access to a gaseous (e.g., air) source, whether such product is stationary or mobile, where the optical device of such product may otherwise be at risk of accumulation thereon of debris, dust, or other airborne particulates.

According to one or more exemplary embodiments, such as the examples shown in FIG. 1, work machines 101, 103 can be configured to operate on a worksite such as a construction site or a mining site. Work machines according to one or more embodiments of the present disclosure, such as the work machines 101, 103, can be manually, autonomously, or semi-autonomously operated. Moreover, work machines according to one or more embodiments of the present disclosure can be locally controlled at the worksite via operator input (manual and/or wireless) and/or remotely controlled from a location remote from the worksite, such as a back-office system 300. The communication between the work machines and the back-office system 300 may be via wired and/or wireless systems.

Regarding the example work machines 101, 103 shown in FIG. 1, such work machines can be configured to perform work tasks in which earthen material is disturbed such that a particulate cloud 105 is generated. More specifically, in the case of the drilling machine 101 the particulate cloud 105 may be caused by a drilling operation and may produce dust and debris in the form of drill cuttings (e.g., rock cuttings and/or chips). In the case of the hauling machine 103, the particulate cloud 105 can be generated by movement of the hauling machine 103 along the surface of the worksite, as part of an unloading operation, and/or as part of a loading operation.

At least one optical device or apparatus 280, which is diagrammatically shown in FIG. 1, can be implemented or provided in the environment 100. According to one or more embodiments, each work machine, such as the work machine 101 and the work machine 103, can have at least one of the optical devices 280. Additionally or alternatively, at least one optical device 280 can be implemented or provided in the environment 100 separate from the work machine(s) 101, 103. The optical device 280 can be enclosed in an isolation chamber or housing, such as described below.

According to one or more embodiments, the optical device 280 can be implemented in association with a controller or processor 250. In general, the controller 250 can control operation of the optical device 280 and/or receive feedback from the optical device 280, such as feedback electronic signals to control the optical device 280 and imaging signals regarding images captured by the optical device 280. The controller 250 may be part of the optical device 280 or separate from the optical device 280 communicatively coupled to the optical device 280.

Optionally, the optical device 280 can be implemented in association with at least one light source 260. The light source 260, which may be part of the optical device 280 or a separate component from the optical device 280, can, according to one or more embodiments, illuminate an area, for instance, an image capture area for the optical device 280. Accordingly, the light source 260 may be regarded as an emitter and/or the optical device 280.

The light output from the light source 260, which can be output from a lamp 265 (e.g., halogen) or a laser, can be light in a predetermined range, for instance, at or about 0.4-2.5 microns, and at a relatively high intensity. According to embodiments of the disclosed subject matter, the light output from the light source 260 can be in the short-wave infrared (SWIR) band. As but one example, the light source 260 may illuminate drill cuttings (e.g., rock cuttings and/or chips) expelled from a drill hole as part of a drilling operation performed by the drilling machine 101, where a camera of the optical device 280 can perform imaging of the illuminated drill cuttings for analysis of the drill cuttings.

The light source 260 can be operatively coupled to the controller 250. As such, the controller 250 can control operation of the light source 260 and/or receive feedback from the light source 260, such as feedback electronic signals to control the light source 260. According to one or more embodiments, the light source 260 may be enclosed in an isolation chamber, such as described below. Controller 250, which can be implemented in circuitry entirely or partially, can include one or more electronic processors, a non-transitory computer-readable media, and one or more input/output interfaces. The electronic processor(s), the computer-readable media, and the input/output interface(s) can be connected by one or more control and/or data buses that allow the components to communicate. It should be understood that the functionality of the controller/processor 250 can be combined with one or more other controllers or processors to perform additional functionality. Additionally, or alternatively, the functionality of the controller/processor 250 can be distributed among more than one controller or processors.

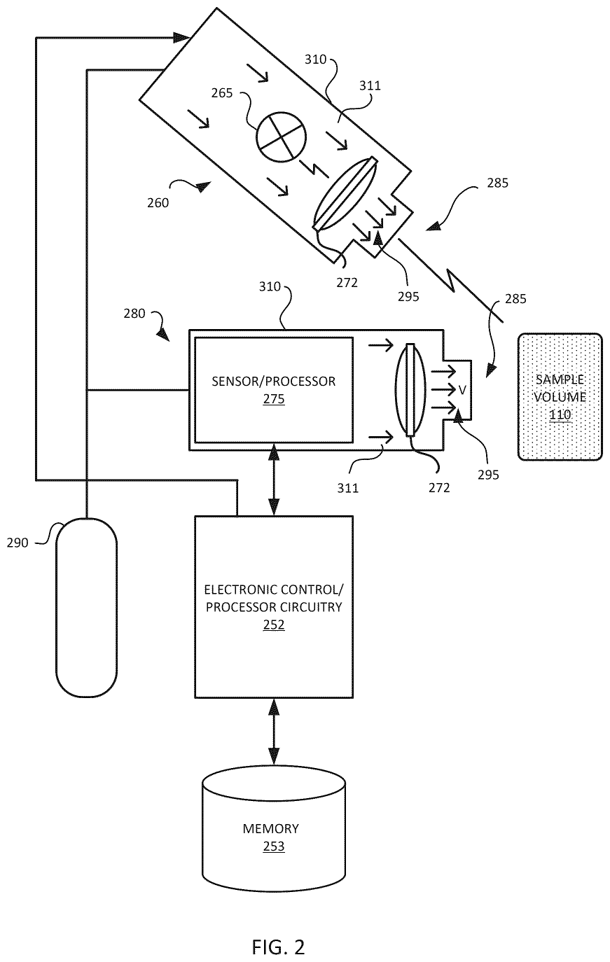

As alluded to above, according to one or more embodiments, the controller/processor 250 can perform processing regarding analysis of the particulate cloud 105, for instance, at or near the point of origin of the particulate cloud 105. Hence, the portion or portions of the controller/processor 250 that perform the analysis of the particulate cloud 105 can be referred to as processing circuitry. According to one or more embodiments, the controller/processor 250 can interface with electronic control/processing circuitry 252 (e.g., as shown in FIG. 2), which may be dedicated to the processing of sensor data, in order to send information to the electronic control/processing circuitry 252 regarding the various operations that the work machine(s), as well as to receive information from the electronic control circuitry regarding quality, characterizations, etc. pertaining to the particulate cloud 105, for instance, from the optical device 280. According to one or more embodiments, the controller 250 can perform analysis regarding one or more states of the optical device 280, for instance, image quality, lens performance or quality (e.g., cleanliness, obstruction, etc.), aperture performance or quality (e.g., cleanliness, obstruction, etc.).

The computer-readable media (e.g., memory 253 as shown in FIG. 2) accessible by the controller 250, whether internal to or external from the controller 250, can store program instructions and data. The electronic processor(s) can be configured to retrieve instructions from the computer-readable media and execute, among other things, the instructions to perform operations or functions pertaining to the analyses of the flow of the particulate cloud 105 according to one or more embodiments of the disclosed subject matter. The input/output interface(s) can transmit data from the controller/processor 250 to systems, networks, and devices located remotely or onboard the apparatus or system having the controller 250, such as the work machine 101, 103 (e.g., over one or more wired and/or wireless connections). The input/output interface(s) can also receive data from systems, networks, and devices located remotely or onboard the apparatus or system having the controller 250, such as the work machine 101, 103 (e.g., over one or more wired and/or wireless connections). The input/output interface(s) can provide received data to the electronic processor(s) and, in some embodiments, can also store received data to the computer-readable media.

According to the one example mentioned above, the optical device 280 can be or include a camera to capture, in real time, images of the particulate cloud 105 as materials are expelled and illuminated by the light source 260. In this context, the particulate cloud 105 may be regarded or characterized as debris cloud 105. In that the materials in debris cloud 105 can be moving relatively fast as noted above, the optical device 280, which can capture visible-band energy reflected from the debris cloud 105, may be a high-speed video camera. Moving image data from optical device 280 can be processed, in real time, to determine, for example, a density of the debris cloud 105 at any point in time. Such density determination can be used when performing analysis of the debris cloud 105 in one or more aspects of the entire analysis system, including determining an appropriate output rate for the drilling machine 101 and/or determining features such as density of the debris cloud 105. According to one or more embodiments the optical device 280 may be a so-called smart camera configured to output processed indications such as density versus time to electronic control circuitry.

As will be described in more detail below, a gas source 290 (see, e.g., FIG. 2) can be implemented to provide a gaseous isolation barrier between the particulate cloud 105 and the optical device 280 and/or the light source 260. The gas provided by the gas source 290 can be air or some other gas, for instance, a so-called clean gas or air. Further, such gas can be pressurized (including compressed) or not, for instance, provided by a fan or a blower. According to one or more embodiments, the gas source 290 may be considered part of the work machine, such as part of the drilling machine 101 or the hauling machine 103. Additionally or alternatively, the gas source 290 may be part of the optical device 280 or the light source 260. The isolation barrier 295 can minimize or prevent particulates, such as the material in the particulate cloud 105, from reaching the light source 260 and/or the optical device 280. More specifically, the isolation barrier 295 may prevent or minimize particulates from the particulate cloud 105 or otherwise from reaching certain operational portions of the optical device 280 or the light source 260, such as a lens of the optical device 280 or an emitter of the light source 260. Hence, such an isolation barrier 295 can allow unobstructed access, particularly direct line-of-sight access based on the arrangement of the light source 260 and/or the optical device 280, free or substantially free of intervening particles. Such isolation barrier 295 can also prevent particulates from reaching the certain operational portions of the optical device 280 and/or the light source 260 to minimize or prevent accumulation of the particulates on such operational portions.

FIG. 2 is a schematic block diagram of a system according to one or more embodiments of the present disclosure. Such system can be for analyzing the particulate cloud 105 in real time by which the present inventive concept can be embodied, though embodiments of the present disclosure are not limited to such a system or application and may implement the optical device 280 without the light source 260 or the light source 260 without the optical device. The system can include the light source 260, the optical device 280, and the gas source 290. Electronic control circuitry 252, which can be representative of some or all of the controller 250, can be part of the system and can be operatively coupled to the optical device 280. The electronic control circuitry 252 may also be operatively connected to the light source 260, for instance, to control on/off and/or intensity of the level of the light output from the light source 260. The electronic control circuitry 252 may be referred to or characterized as processing circuitry. Optical device 280, which in some respects may be characterized on its own as a sensor, together with the electronic control circuitry 252, may be referred to generally as processing circuitry. Of course, individually the optical device 280 and the electronic control circuitry 252 each can be characterized as processing circuitry.

Regarding layout, in this particular example, the output the light source 260 can be directed to impinge and reflect off material in sample volume 110 of the particulate cloud 105. The input of the optical device 280 can be directed to receive light from the light source 260 reflected from the sample volume 110 as the material in the particulate cloud 105 fly past the optical device 280.

The output of the gas source 290 (which may include multiple outputs) can be provided through the inner volume 311 of an enclosure 310 of each of the optical device 280 and the light source 260. Optionally, the enclosure 311 can be regarded as part of the optical device 280 and/or the light source 260. The gas source 290 can provide gas in the form of the isolation barrier 295 between the particulate cloud 105 and the enclosure 310. Such gas provided by the gas source 290 through the inner volume 311 of the enclosure 310 can prevent material from the particulate cloud 105 from entering at least the inner volume 311. According to one or more embodiments, the gas through the inner volume 311 of the enclosure 310 can prevent material from the particulate cloud 105 from entering an optical aperture 285 of the enclosure 310 due to the exit of the gas from the optical aperture 285. In that the enclosure 310 provided with the gas from the gas source 290 can prevent material from entering the at least the inner volume 311, the enclosure 310 may be regarded as an isolation chamber. As illustrated in FIG. 2, embodiments of the present inventive concept may contain both the air barrier 295 as well as an optical aperture within the isolation chamber 310, as will be described in more detail below.

Optical aperture 285 in each of the light source 260 and the optical device 280 may coincide with an air outlet that directs an airstream out of the optical device 280 and the light source 260 at an exit velocity V. The exit velocity V for each of the optical device 280 and the light source 260, which may be different from each other, can be established to be greater than the velocity of the material of the particulate cloud 105 (or particulate stream) by configuration of the housing 310, for instance, configuration of the housing 310 at the output thereof to output the exiting airstream provided by the gas source 290. As described more fully below, the exit velocity V can be established by the dimensions of an exit tube at the optical aperture 285.

According to one or more embodiments, the optical device 280 may be constructed as a spectrometer and the spectra of candidate minerals can be provided in a database in the memory 253 of the electronic control circuitry 252 or otherwise accessible by the electronic control circuitry 252. The memory 253, which may be referred to or characterized as a spectral database in whole or in part, may be a so-called library of known or expected minerals at the worksite, or even specific to worked material.

Optical device 280 may include a sensor/processor component 275 by which data can be collected through optics 272 and formatted for further processing. Electronic control circuitry 252 may accept and process such data according to the end-usage of optical device 280 (e.g., camera, spectrometer, etc.). Optionally, the light source 260 may include optics 272, which can be different from the optics 272 for the optical device 280.

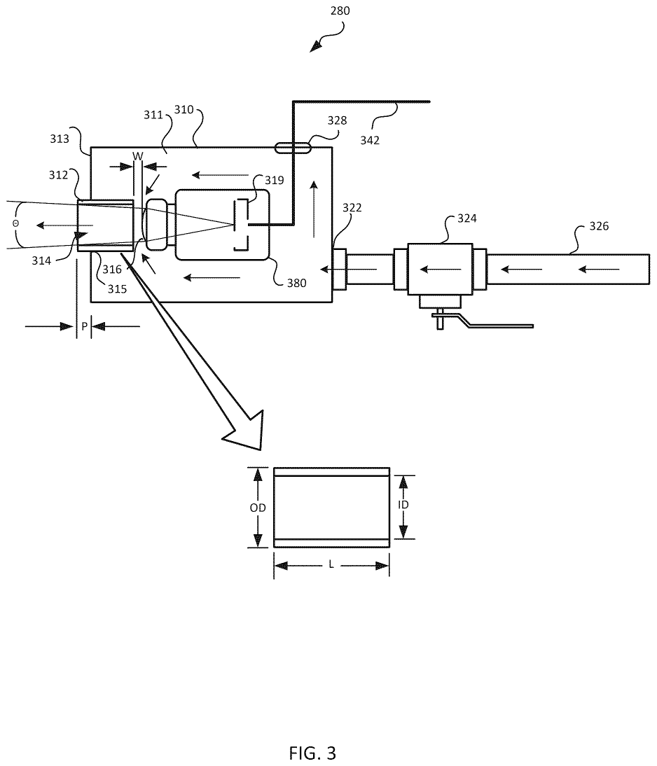

FIG. 3 is a sectional view of the optical device 280 according to one or more embodiments of the present disclosure with which the present inventive concept can be embodied. The present inventive concept can be practiced with a variety of optical devices including a sensor, a spectrometer, and a camera, and a light/emitter source. In this example, the optical device 280 can be regarded as including an optical device 380 and the enclosure 310. According to one or more embodiments, the optical device 380 can be the same as or similar to the optical device 280 described above exclusive of the enclosure 310. The optical device 380 may be equipped with a lens 316 that, in combination with internal application-specific optical components, focuses energy (visible light, SWIR, etc.) onto an internal sensor 319 designed to convert the impinging radiation into an application-specific data signal carried by a transmission line 342. Such data signal may include imagery, video, spectra, etc., depending on the type of internal sensor 319 used. Optionally, the transmission line 342 can provide power to the optical device 380, though different power and data transmission lines may be implemented.

As illustrated, the optical device 380 may be contained within the inner volume 311 of the enclosure 310. The enclosure 310, which may be regarded as or otherwise define an isolation chamber, may be constructed or otherwise configured to realize the isolation barrier 295, as discussed above. It is to be understood that the present inventive concept can be practiced with isolation media specific to the application (infrared-transparent media, for example). The interior of enclosure 310 may receive a supply of gas from a supply line 326 and through inlet port 322. The supply line 326 can be coupled to the gas source 290 or considered part of the gas source 290. A valve 324 may be inserted into supply line 326 to control the flow of gas through the inner volume 311 of the enclosure 310. Gas from the gas source 290 may fill the inner volume 311 of the enclosure 310 and may be maintained at a specific air pressure to implement the isolation barrier 295.

The enclosure 310 may have an exit port 315 from which the gas flowing through the inner volume 311 can exit the enclosure 310. The exit port 315 may be on a side of the enclosure 310 opposite the inlet port 322, such as shown in FIG. 3, where FIG. 3 shows the exit port 315 on a front wall 313 of the enclosure 310. Further, the exit port 315 may have a central axis thereof aligned with a central axis of the optical device 280, for instance, of the lens 316 thereof, such as shown in FIG. 3. Though FIG. 3 may be regarded as showing only one exit port 315, one or more embodiments of the present disclosure may have multiple distinct exit ports 315.

Exit port 315 may have an exit tube 312 installed therein forming a gas passage 314 through which gas from the inner volume 311 can be directed and expelled. The exit tube 312 may be the only way by which the gas from the inner volume 311 may exit the enclosure 310, at least during operation of the optical device 280. That is, the exit tube 312 in the exit port 315 may be the only exit for the gas from the inner volume 311. Alternatively, multiple exit tubes 312 may be respectively provided in corresponding ones of the exit ports 315. Further, gas exiting the inner volume 311 via the exit port 315 may only exit by first passing through an entrance opening of the exit tube 312 at the first end thereof, which can be adjacent to but spaced from the optical device 380, particularly the lens 316 thereof, such as shown in FIG. 3.

As illustrated in FIG. 3, exit tube 312 may be length L long defined by the first end and a second end opposite the first end. The exit tube 312 may also have an outer diameter OD and an inner diameter ID. According to one or more embodiments, the inner diameter ID of the exit tube 312 can be less than the length L of the exit tube 312. The inner diameter ID may have a circular or oval cross-section in an end view of the exit tube 312. Optionally, the inner diameter ID may be a constant value along the entire length L of the exit tube 312. Outer diameter OD may be sized to fit within exit port 315 and may be fixed therein, such as by welding, gluing, interference fit, etc.

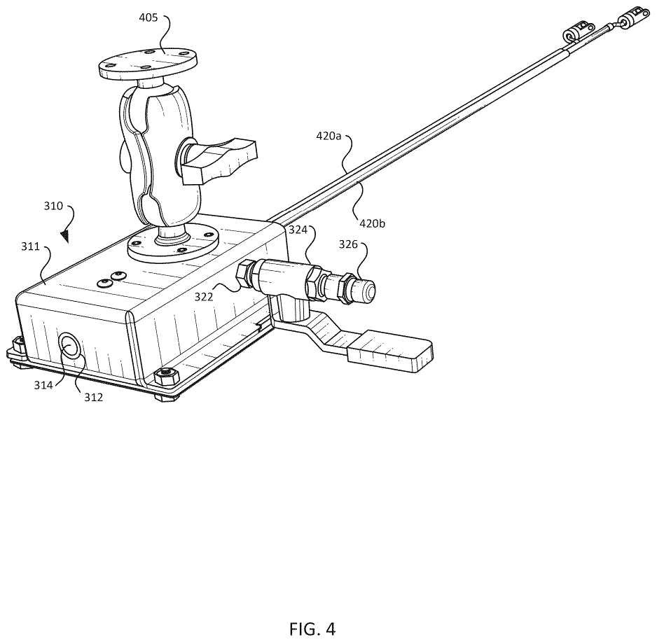

Inner diameter ID, in combination with length L and distance W may serve as an aperture stop defining the FOV Θ for optical device 380. Additionally, as shown in FIG. 3, for instance, the exit tube 312 may simultaneously extend a distance P forward of an outer surface of the front wall 313 of the enclosure 310 and a distance W from lens 316 or other optical aperture (e.g., 285 of FIG. 2). Such distance W may be such that appropriate gas flow can enter the entrance of the exit tube 312. The exit tube 312 may also extend or project from the front wall 313 into the inner volume 311 of the enclosure 310, toward the optical device 380. In certain embodiments, exit tube 312 may be flush with the outer surface of the front wall 312 of the enclosure 310 (P=0), for instance, as illustrated in FIG. 4. The positioning of the exit tube 312 may be non-adjustable or, alternatively, adjustable and set, for instance, via a threaded interface between outer diameter OD and the portion of the enclosure 310 defining the exit port 315. Thus, the amount by which the second end of the exit tube 312 projects from the front wall 313, the amount by which the first end of the exit tube 312 projects into the interior of the enclosure 310, and the distance W may be adjusted and set prior to operation of the optical device 280.

Exit tube 312 may serve multiple purposes including setting a field of view (FOV) Θ for optical device 380 and moving the gas egress forward (away from optical device 380) of and away from lens 316. It is to be understood that exit tube 312 may be inserted into exit port 315 of enclosure 311 or exit tube 312 may be fabricated in single piece formation with enclosure 311. Thus, the exit tube 312 may or may not be considered part of the enclosure 310.

When assembled with the optical device 280 and the exit tube 312, the enclosure 310 may be gastight (e.g., airtight) other than at the gas passage 314. Accordingly, a seal 328 may be inserted into a wall of enclosure 310 to fit around transmission line 342 in a gas-tight manner.

The dimensions of exit tube 312 may be selected to fulfill a desired FOV Θ and, at the same time, the velocity of the gas stream that exits through exit tube 312. For example, length L may be maximized, and inner diameter ID may be minimized while maintaining the desired FOV Θ. Further, distance W may be minimized to maximize FOV Θ while still maintaining a cross-sectional area that meets the desired gas stream velocity V. That is, for example, π×W×ID≥π×(ID/2)² may produce the desired gas stream velocity. Such velocity can be of sufficient magnitude to minimize (including prevent) particulates from reaching the optical device 380, for instance, from even entering the exit tube 312.

FIG. 4 is an illustration of an exemplary enclosure 310 (e.g., isolation chamber) by which the present inventive concept can be embodied. Enclosure 310 can include the gas inlet port 322. As described above, the enclosure 310 may be connected to the supply line 326 of the isolation medium (e.g., gas such as air). The valve 324 may be inserted between the supply line 326 and the inlet port 322 to modulate the medium pressure within enclosure 310. The enclosure 310 may have the exit tube 312 defining the gas passage 314.

In some embodiments, the enclosure 310 may have a mount 405 that may be used to point the exit tube 312 toward a desired location or direction, for instance, toward the debris cloud 105 or to where the debris cloud 105 is anticipated to be. Additionally, a pair of electrical cables 420a and 420b, e.g., one for electrical power and the other for data from the optical device 318, may extend from the enclosure 310.

It is to be noted that exit tube 312 may be flush with the enclosure 410 of enclosure 310. Indeed, the present inventive concept can be practiced for distances P≥0 between the forward end (away from lens 316) of enclosure 310 and the forward end of exit tube 312 (see FIG. 3).

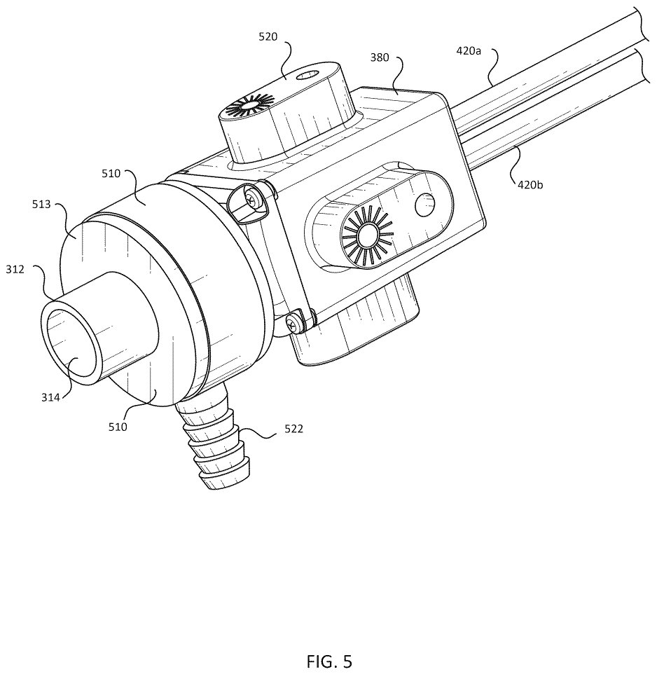

FIG. 5 is an illustration of an exemplary optical device 380 by which the present inventive concept can be embodied. Optical device 380 may include one or more mounting blocks, representatively illustrated at mounting block 520, that can be constructed or otherwise configured to mount the optical device 380 at a suitable location, for instance, on a work machine, such as the drilling machine 101 or the hauling machine 103. In the illustrated example, the enclosure 510 can encompasses the aperture (e.g., aperture 285), be it a lens or other optical element, but can be external to the optical device, at least partially (e.g., by distance P>0). That is, the enclosure 510 can surround only the optical aperture and the first end of the exit tube 312 and not the remaining portions of the optical device 380. Optionally, the second end of the exit tube 312 may project from a front wall 513 of the enclosure 510, or alternatively may be flush with the front wall 513. A gas inlet 522 may be in fluid communication with the interior of enclosure 510 in a manner previously described.

### INDUSTRIAL APPLICABILITY

As noted above, the present disclosure can be regarded as generally relating to mitigation (including prevention) devices, systems, and methods. According to one or more embodiments, an enclosure for an optical device (which may or may not include an emitter) used in high dust or debris environments and systems and methods thereof can be implemented or provided.

Such system or portion(s) thereof may be sold as an aftermarket kit, for instance, just a mitigation enclosure (isolation chamber), just an exit tube coupleable to the enclosure, or both the enclosure and the exit tube. Gas can be provided so as to flow through an inner volume of the enclosure and out of the exit tube. The exit tube can be dimensioned (e.g., size, shape, length, cross-sectional area, etc.) and positioned such that the flow rate of the gas through the exit tube can minimize (including prevent) particulates such as dust or debris from flowing into the exit tube and reaching an optical device provided relative to the exit tube. Such flow rate can be specific to the type or expected type of particulates having the potential to enter the exit tube. Such operation can minimize (including prevent) the particulates from contacting the optical device or portion thereof, such as a lens or emitting surface of the optical device. This can prevent accumulation of the particulates on the optical device or portion thereof.

Systems, apparatuses, and methods according to one or more embodiments of the present disclosure may be integrated with a structure or machine used where a clean optical device may be required including, but not limited to, environments with high amounts of dust and debris, such as drilling or mining operations.

One or more embodiments of the present disclosure can also include or pertain to an isolation enclosure for optical devices and emitters. An isolation media gas (e.g., air, nitrogen, etc.) under pressure can be injected into the enclosure. One or more tubular apertures can be provided in the enclosure for the emission or detection purposes of the device. The tubular aperture(s) can provide an escape path for the pressurized isolation media wherein an “airstream” of substantial velocity can be created within the tube. The airstream can prevent debris or the like from entering the enclosure and from impinging on the optical device/emitter.

One or more embodiments of the present disclosure can thus entail a substantially sealed enclosure for a device (visible or non-visible wavelength camera, light source, etc.) wherein an isolation media gas (e.g., air, nitrogen, etc.) under pressure can be injected into the enclosure. One or more tubular apertures can be provided in the enclosure for the emission or detection purposes of the device. The tubular aperture(s) can also provide an escape path for the pressurized isolation media such that the flow of the media gas can be of substantial velocity within the tube. This flow of gas can prevent debris or the like from entering the enclosure and from impinging on the device because the debris is not able to travel upstream through the flow of the isolation media to reach the device. The flow of media may optionally be controlled to a level that prevents debris entry while minimizing waste of isolation media.

One or more embodiments of the disclosed subject matter can involve or implement real-time ore characterization using an optical device such as a high-speed visible camera.

Embodiments of the disclosed subject matter can provide for real-time analysis of debris cloud as the debris cloud is created, particularly in a case where the material of debris cloud 105 are flying out past the sensing components at a relatively fast rate (e.g., at or about at a velocity of 5000 ft./min or 60 mph.

Embodiments of the disclosed subject matter can also be as set forth according to the following parentheticals.

(1). An isolation chamber for an optical device comprising: an enclosure; an inlet port constructed to supply an isolation medium into the enclosure; and an exit tube constructed to direct a stream of the isolation medium out of the enclosure, the exit tube having a length and an inner diameter, the exit tube extending into the enclosure, the length, the inner diameter and the distance from a lens of the optical device and the exit tube establishing a selected field of view and the exit velocity of the stream of the isolation medium passing through the exit tube at the forward of the end thereof.

(2). The isolation chamber of (1), wherein the optical device is contained within the enclosure.

(3). The isolation chamber of (1) or (2), wherein the optical device is surrounded by the isolation medium within the enclosure.

(4). The isolation chamber of any one of (1) to (3), wherein the enclosure is external to the optical device.

(5). The isolation chamber of any one of (1) to (4), wherein only a lens of the optical device and a rearward end of the exit tube are contained in the enclosure.

(6). The isolation chamber of any one of (1) to (5), wherein the optical device is a visible light camera.

(7). The isolation chamber of any one of (1) to (6), wherein the optical device is a spectrometer.

(8). The isolation chamber of any one of (1) to (7), wherein the exit tube extends at one end thereof an extension length from outside the enclosure.

(9). The isolation chamber of any one of (1) to (8), wherein the product of the distance between the lens of the optical device and the inner diameter of the exit tube is greater than or equal to an inner radius of the exit tube squared.

(10). The isolation chamber of any one of (1) to (9), wherein the exit velocity of the stream of the isolation medium is proportional to the velocity of debris particles forward of the end of the exit tube.

(11). A work machine that generates debris during a work task, the work machine comprising: an optical device constructed to analyze the debris; an isolation chamber having an enclosure; an inlet port constructed to supply an isolation medium into the enclosure; and an exit tube constructed to direct a stream of the isolation medium out of the enclosure, the exit tube having a length and an inner diameter, the exit tube extending into the enclosure, the length, the inner diameter and the distance from a lens of the optical device and the exit tube establishing a selected field of view and the exit velocity of the stream of the isolation medium passing through the exit tube at the forward of the end thereof.

(12). The work machine of (11), wherein the optical device is contained within the enclosure.

(13). The work machine of (11) or (12), wherein the optical device is surrounded by the isolation medium within the enclosure.

(14). The work machine of any one of (11) to (13), wherein the enclosure is external to the optical device.

(15). The work machine of any one of (11) to (14), wherein only a lens of the optical device and a rearward end of the exit tube are contained in the enclosure.

(16). The work machine of any one of (11) to (15), wherein the optical device is a visible light camera.

(17). The work machine chamber of any one of (11) to (16), wherein the optical device is a spectrometer.

(18). The work machine of any one of (11) to (17), wherein the exit tube extends at one end thereof an extension length from outside the enclosure.

(19). The work machine of any one of (11) to (18), wherein the product of the distance between the lens of the optical device and the inner diameter of the exit tube is greater than or equal to the radius of the exit tube squared.

(20). The work machine of any one of (11) to (19), wherein the exit velocity of the stream of the isolation medium is proportional to the velocity of debris particles forward of the end of the exit tube.

The present inventive concept addresses the accumulation of debris on the optical aperture of the optical device. This is achieved in various embodiments by providing a stream of an isolation medium that locates the exiting stream of isolation medium away from the optical device and exterior to an isolation chamber.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

What is claimed is:

1. An isolation chamber for an optical device comprising:
an enclosure;
an inlet port constructed to supply an isolation medium into the enclosure; and
an exit tube constructed to direct a stream of the isolation medium out of the enclosure,
wherein the exit tube has a length and an inner diameter, the exit tube extending into the enclosure, the length, the inner diameter and the distance from a lens of the optical device, and the exit tube establishing a selected field of view and an exit velocity of the stream of the isolation medium passing through the exit tube at a forward end thereof.

2. The isolation chamber of claim 1, wherein the optical device is fully contained within the enclosure.

3. The isolation chamber of claim 2, wherein the optical device is surrounded by the isolation medium within the enclosure.

4. The isolation chamber of claim 1, wherein the enclosure is external to the optical device.

5. The isolation chamber of claim 4, wherein only a lens of the optical device and a rearward end of the exit tube are contained in the enclosure.

6. The isolation chamber of claim 1, wherein the optical device is a visible light camera.

7. The isolation chamber of claim 1, wherein the optical device is a spectrometer.

8. The isolation chamber of claim 1, wherein the exit tube extends at the forward end thereof an extension length from outside the enclosure.

9. The isolation chamber of claim 1, wherein the product of the distance between the lens of the optical device and the inner diameter of the exit tube is greater than or equal to an inner radius of the exit tube squared.

10. The isolation chamber of claim 1, wherein the exit velocity of the stream of the isolation medium is proportional to a velocity of debris particles forward of the forward end of the exit tube.

11. A system comprising:
an optical device;
an enclosure defining an isolation chamber;
an inlet port constructed to supply an isolation medium into the enclosure; and
an exit tube constructed to direct a stream of the isolation medium out of the enclosure,
wherein the exit tube has a length and an inner diameter, a first end of the exit tube extending into the enclosure, the length, the inner diameter, and a distance from a lens of the optical device and the exit tube establishing an exit velocity of the stream of the isolation medium passing through the exit tube.

12. The system of claim 11, wherein the optical device is contained within the enclosure.

13. The system of claim 12, wherein a first portion of the exit tube extending into the enclosure is longer than a second portion of the exit tube protruding from the enclosure external to the enclosure.

14. The system of claim 11, wherein the enclosure is external to the optical device.

15. The system of claim 14, wherein the length of the exit tube is greater than the inner diameter of the exit tube.

16. The system of claim 11, wherein the optical device is a visible light camera.

17. The system of claim 11,
wherein a cross-section of the exit tube is circular, and
wherein the enclosure is constructed such that the exit tube is the only way in which the isolation medium is able to escape the enclosure when the system is operating.

18. The system of claim 11, wherein the exit tube extends at one end thereof an extension length from outside the enclosure.

19. The system of claim 11, wherein the product of the distance between the lens of the optical device and the inner diameter of the exit tube is greater than or equal to the radius of the exit tube squared.

20. The system of claim 11, wherein the exit velocity of the stream of the isolation medium is proportional to the velocity of debris particles forward of the end of the exit tube.
